(19) United States
(12) Patent Application Publication
(10) Pub. No.: US 2025/0262533 A1
(43) Pub. Date: Aug. 21, 2025

(54) DATA PROCESSING APPARATUS AND METHOD

(71) Applicant: Sony Interactive Entertainment Inc., Tokyo (JP)

(72) Inventors: Jesus Lucas Barcias, London (GB); Calum Armstrong, London (GB); Ryan Spick, London (GB); Nicholas Anthony Edward Ryan, London (GB); Adrian Barahona Rios, London (GB); Alan Murphy, London (GB)

(73) Assignee: Sony Interactive Entertainment Inc., Tokyo (JP)

(21) Appl. No.: 19/050,511

(22) Filed: Feb. 11, 2025

(30) Foreign Application Priority Data
Feb. 16, 2024 (GB) 2402216.2

(51) Int. Cl. A63F 13/424; A63F 13/533; A63F 13/79

(52) U.S. Cl. CPC A63F 13/424; A63F 13/533; A63F 13/79

(57) ABSTRACT

A data processing apparatus comprising circuitry configured to: receive data indicating an audio sample captured in a physical environment of a player of a video game; determine a classification of the audio sample; determine an in-game occurrence associated with the determined classification of the audio sample; and control the determined in-game occurrence to be executed in the video game.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Video games are often, by their very nature, very different to reality. For example, video games allow a user to become immersed in exciting and intricate virtual worlds while remaining in their own home.

A problem, however, is that occurrences in a user's real world environment can negatively affect their immersion in the game world. For example, people talking or moving around in the physical room the user is playing the video game in or even sounds external to the room which come in through an open door or window (e.g. the sound of rain when, in the video game, it is sunny, or the sounds of people going about their daily business outside) can often detract from the illusion that a user is inside the game world. This can negatively affect the user's enjoyment of the game.

There is therefore a desire for a technical solution to help enhance user immersion in a video game.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3 schematically shows input and output of a classifier;

FIGS. 4A and 4B schematically show a first example of controlling a video game based on classification of detected sound;

FIGS. 5A and 5B schematically show a second example of controlling a video game based on classification of detected sound;

FIGS. 6A and 6B schematically show a third example of controlling a video game based on classification of detected sound;

FIG. 7 shows an example lookup table;

FIG. 8 schematically shows an example of providing a bespoke experience to a user based on detected audio; and

FIG. 9 shows an example method.

Like reference numerals designate identical or corresponding parts throughout the drawings.

### DETAILED DESCRIPTION OF THE EMBODIMENTS

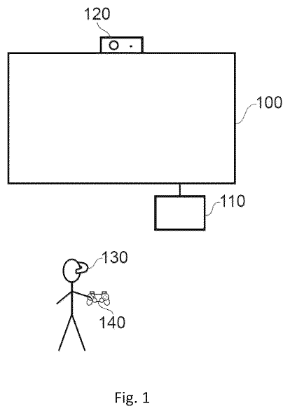

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

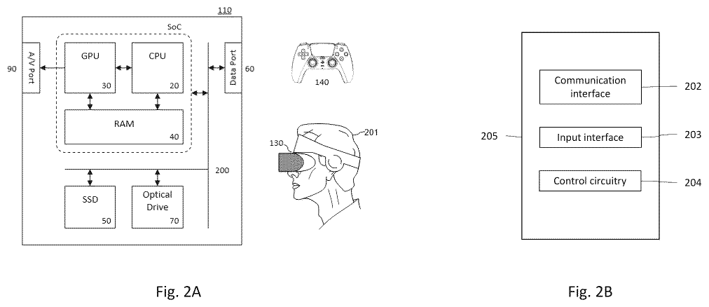

FIG. 2A shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

In an example, if the peripheral device 205 is a controller (like controller 140), the input interface 203 comprises buttons, joysticks and/or triggers or the like operable by the user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

The present technique allows occurrences in a video game to be controlled based on detected sounds in a user's environment.

In an example, sounds of the users physical environment are detected by a microphone (e.g. a microphone connected to the games console 110, such as that of integrated controller and microphone 120, or a microphone forming part of the input interface 203 of peripheral device 205, such as a microphone integrated in controller 104) and classified as one of a plurality of predetermined sound classifications (that is, sound categories or types).

For instance, detection of footsteps may result in the classification “footsteps”, detection of a dog barking may result in the classification “dog barking”, detection of a doorbell ringing may result in the classification “doorbell”, etc. The sound classification is then used to control an occurrence in the video game. For instance, sound classified as “footsteps” may result in a non-player character (NPC) walking past a player-controlled character in a game, sound classified as “dog barking” may cause a dog character to appear in the game and sound classified as “doorbell” may cause in-game characters to turn their heads or bodies in response to the doorbell.

This helps reduce the perceivable boundary between the gaming world and the real world, thereby improving user immersion in the gaming experience.

In an example, if the microphone is configured to detect a direction from which a classifiable sound is detected (e.g. if the microphone comprises a plurality of directional microphones configured to detect sound from different respective direction), this directional information can also be used to control the resulting occurrence in the video game. For example, if the sound of a dog barking is detected from the left, a dog character may appear on the left hand side of the screen (or on a left hand side of a user's field of view if using a virtual reality headset, for example). On the other hand, if the sound of the dog barking is detected from the right, the dog character may appear on the right hand side of the screen (or on a right hand side of a user's field of view if using a virtual reality headset, for example).

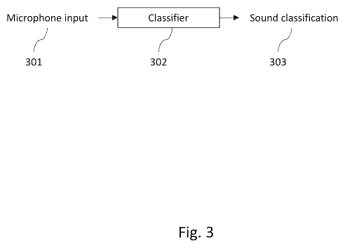

FIG. 3 shows an example arrangement for classifying detected sounds. It includes a microphone input 301, a classifier 302 and an output sound classification. The classifier 302 is implemented by the CPU 20 and/or GPU 30 of the games console 110. Alternatively, or in addition, it may be implemented by an external server (not shown) which communicates with the games console over a network (such as the internet).

The microphone input 301 is data representing recorded audio detected by the microphone. In an example, while a video game is being played, audio samples are continuously and periodically captured by the microphone. Thus, for a set audio capture time period (e.g. a predetermined time period such as 3, 5 or 10 seconds), a first sample is captured over a first instance of that time period, a second sample is captured over a second, subsequent, instance of that time period, a third sample is captured over a third, subsequent, instance of that time period, and so on. Data representing each audio sample is then passed to the classifier 302.

The classifier 302 uses any suitable known technique to classify each audio sample. For instance, the classifier 302 may use any known suitably trained deep learning model (trained with, for example, 10000 labelled audio samples) to classify each audio sample.

The classifier 302 may implement a plurality of steps.

In a first step, any sound generated by the game itself and captured by the microphone during the time period during which the audio sample was captured is removed from the sound sample. In an example, the classifier is provided, by the game application, with timestamped data representing the audio output of the game in order to detect and, if detected, filter this game audio from the audio sample captured by the microphone. For example, a volume of the game audio in the captured audio sample may be determined (e.g. based on the average intensity of spectral component(s) characteristic of the game audio detected in the captured audio sample) and active noise cancellation may be used to suppress these components from the captured audio sample. This means the subsequent processing of the captured audio sample includes only sound in the user's environment other than that generated by the game itself (which may be output by loudspeaker(s) (not shown) integrated in the display device 100 or included in a sound bar and/or surround sound system, for example). This helps reduce the risk of an undesirable feedback loop being established in the game. For example, it helps prevent the sound of a dog barking in the game being classified as “dog barking” in the real world environment and thus causing more and more virtual dogs to appear in the game.

In a second step, assuming the captured audio sample (with any detected game audio now filtered out) is represented by data representing an audio wave, a spectrogram is generated from the audio wave. The spectrogram is an image showing how the spectrum of frequencies of the audio wave changes over the audio captured time period. The spectrogram may be a heat map, for example, showing frequency along one axis, time along another axis and with the intensity of each frequency being shown by varying colour or brightness.

The spectrogram is thus an image representing the captured audio sample. This allows, in a third step, classification of the audio sample via a suitably trained deep learning model. The deep learning model may comprise a convolutional neural network (CNN) and linear classifier, for example. Various such deep learning models are known in the art and are therefore not discussed in detail here. The output of the deep learning model is one of the predetermined classifications (e.g. “footsteps”, “dog barking”, etc.) the deep learning model was trained with. The output of the third step is thus the sound classification 303.

In an example, each successively captured audio sample is classified in this way to generate an output stream of sound classifications 303 as the video game is played. This allows occurrences in the video game to be controlled in real time based on detected sounds in the user's physical environment.

In an example, the games console 110 may detect whether or not audio output of the game itself (in-game or game-produced audio) is likely to be picked up by the microphone. If it is not likely to be picked up, the first step of detecting and removing in-game audio may be skipped to reduce the amount of processing carried out by the classifier 302. In an example, the games console 110 may determine whether in-game audio is being output to the user via earphones or headphones (that is, personal audio speakers which only the user can hear and for which output audio is thus not likely to be detectable by the microphone). If the user is using earphones or headphones in this way, then the first step is skipped.

The games console 110 may determine whether wired earphones or headphones are being used based on detection of a physical headphone plug in a physical headphone socket (not shown) of the games console 110 or controller 140, for example. The games console 110 may determine whether wireless earphones or headphones are being used based on detection of a wireless indicator transmitted by the earphones or headphones (e.g. as included in a Bluetooth address or name). In another example, if a separate wireless dongle (connectible to the games console 110, not shown) is used to enable the wireless functionality of the earphones or headphones, detection of such a dongle and the successful establishment of a wireless audio channel between the dongle and the earphones or headphones indicates to the games console 110 that the earphones or headphones are being used (and thus the above-mentioned first step is skipped).

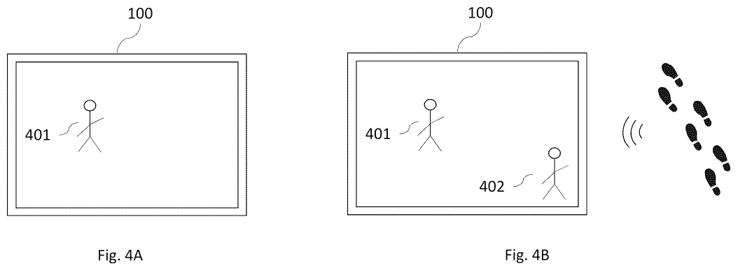

FIGS. 4A and 4B show a first example of controlling a video game in real time based on classification of detected sound.

FIG. 4A shows an output screen of the video game displayed on the display device 100 before any environmental sound is detected (in all examples, if no sound is detected, the video game is controlled according to a default setting). Here, only one character 401 (a player-controlled character) is shown.

FIG. 4B shows the output screen after an environmental sound classified as “footsteps” is detected. Because of the detection of footsteps in the latest captured audio sample, a new character (NPC 402) is shown walking past the character 401. The real life sound of footsteps (due to another person walking past the user as they are playing the game, for example) is thus used to control the corresponding appearance of another character walking in the game, thereby helping maintain user immersion in the game despite potential distractions in the user's physical environment.

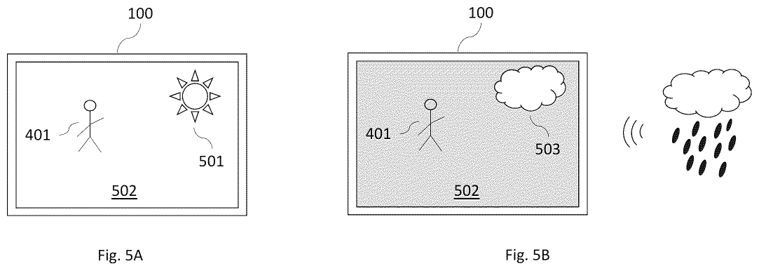

FIGS. 5A and 5B show a second example of controlling a video game in real time based on classification of detected sound.

FIG. 5A shows an output screen of the video game displayed on the display device 100 before any environmental sound is detected. Here, the player-controlled character 401 is again shown and, as a default, the simulated weather in the in-game environment 502 is sunny (as indicated by the appearance of sun 501).

FIG. 5B shows the output screen after an environmental sound classified as “rain” is detected. Because of the detection of rain in the latest captured audio sample, the in-game weather is changed. The sun 501 is replaced with a cloud 503 and, as a result, the lighting of the in-game environment 502 becomes darker. The real life sound of rain (the sound coming in through an open window or door in the user's physical environment as they are playing the game, for example) is thus used to control the in-game weather in a corresponding way. Consistency of the real life and in-game weather is thus achieved, thus helping improve user immersion in the game.

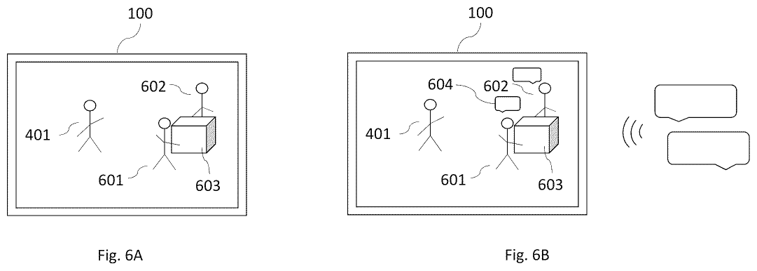

FIGS. 6A and 6B show a third example of controlling a video game in real time based on classification of detected sound.

FIG. 6A shows an output screen of the video game displayed on the display device 100 before any environmental sound is detected. Here, the player-controlled character 401 is again shown. There are also two NPCs 601 and 602 facing each other over an obstacle 603 (e.g. table or crate) in the game. As a default, the NPCs 601 and 602 are not talking to each other.

FIG. 6B shows the output screen after an environmental sound classified as “voices” is detected. Because of the detection of voices in the latest captured audio sample, NPCs 601 and 602 are controlled to start an in-game conversation with each other. The conversation is indicated by speech bubbles 604 (although the in-game conversation may be defined by audio output, in which case the speech bubbles 604, which may contain text defining the conversation, need not be displayed). The real life sound of voices (based on the user having a conversation with someone else in the physical environment or by conversation between two or more people in the physical environment other than the user being detected by the microphone, for example) is thus used to control the occurrence of conversation between in-game characters in a corresponding way. Consistency of real life and in-game ambient conversation is thus achieved, thus helping improve user immersion in the game.

The above examples may be enabled, for example, by a lookup table provided by each game (e.g. as part of the game software application) mapping each predetermined sound classification with a corresponding in-game occurrence. Upon output of a sound classification 303 by the classifier 302, the corresponding in-game occurrence is looked up and corresponding code is executed by the game software application. For instance, in the above examples, the output of the sound classification “footsteps” causes code to be executed to cause the appearance of character 402, the output of the sound classification “rain” causes code to be executed to cause the in-game weather change from sunny to rainy and the output of the sound classification “voices” causes code to be executed to cause the NPCs 601 and 602 to begin conversing. In an example, the lookup table also indicates a default in-game occurrence to be executed when no sound is detected by the microphone (e.g. if the user is playing in a completely silent room).

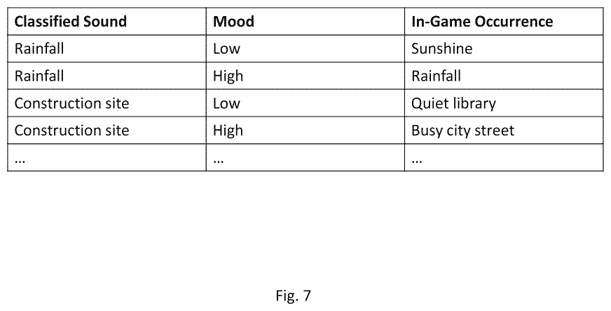

One or more other factors may also be used, in addition to the current output sound classification 302, to determine an in-game occurrence. One such factor is one or more detected physiological characteristics of the user indicative of a state of the user. For example, a likely mood (emotional state) of the user may be determined. This is exemplified in FIG. 7, which shows an extended lookup table to that previously described.

As well as showing a relationship between sound classification and in-game occurrence, the lookup table of FIG. 7 additionally includes a “Mood” column indicating a mood of the user. A given sound classification is thus associated with a plurality of possible in-game occurrences and the in-game occurrence which is executed depends on a mood of the user as indicated, for example, by one or more detected physiological characteristics of the user. In the example of FIG. 7, each sound classification is associated with two moods (“high”, indicating the user is in a good or happy mood, and “low”, indicating the user is in a sad or frustrated mood). This is for simplicity and, in reality, a different number of moods (and corresponding in-game occurrences) for each sound classification may also be used. In the example of FIG. 7, two sound classifications, “Rainfall” and “Construction site” are shown. Again, this is for simplicity and, in reality, a larger number of sound classifications (e.g. 10, 20, 50 or 100) may be included in the lookup table.

By detecting a likely mood of the user and using this, together with the current sound classification, to determine an associated in-game occurrence, the immersion of the user in the video game experience may be improved in a way which is appropriate to the detected mood of the user. This helps provide a bespoke gaming experience to each user.

For example, looking again at FIG. 7, if “Rainfall” is detected and the user is determined to be in a low mood, the in-game weather is made to be sunshine (rather than rain). This takes into account that, when in a low mood, a user may be more likely to be playing a video game to provide a sense of escape and/or to improve their mood. Providing sunny weather in the video game in contrast to the rain of the real world may help the user achieve this goal.

On the other hand, if “Rainfall” is detected and the user is determined to be in a high mood, the user may be more likely to desire improved consistency between the game world and real world to achieve improved immersion. That is, rather than a user wishing to achieve an improved mood through a sense of escape (since they are already in a good mood), they may be more interested in achieving improved immersion and realism as they play the game. This realism is achieved by making it rain in the game (with in-game “Rainfall”) to match the detected “Rainfall” in the real world.

The other example of how this principle may be applied in FIG. 7 is the classification of “Construction site” sound. Such sound may be detected, for instance, if a user is playing the game in a city-centre apartment and there is construction or maintenance noise close by which is picked up by the microphone (e.g. through an open window of the apartment).

“Construction site” sound (e.g. including drilling, hammering, construction workers shouting to each other, etc.) can be stressful to hear. If the user is in a low mood, this stress may negatively affect their mood further.

Thus, when the user's mood is detected as “Low” when “Construction site” sound has been detected, the in-game environment is changed to an environment known to be quiet and calm. In this case, such an environment is a library. This (together with other functionalities available to the user, such as noise cancellation through suitable noise cancelling headphones or the like) may help provide a sense of calm and serenity for the user in contrast to the undesirable construction noise in the real world, thereby helping improve their mood. One or more other functionalities available to the user could also be used to help provide a quiet and calm in-game environment. For example, if the game audio is output by noise cancelling headphones worn by the user, the noise cancellation may be activated (or the level of noise cancellation may be increased).

On the other hand, when the user's mood is detected as “High”, the user may be more likely to wish their gaming environment to more closely correspond to what is going on around them in the physical world to improve their sense of immersion. Thus, in this case, rather than the in-game environment being changed to a calm and serene library, the in-game environment is changed to (or maintained as) a busy city street incorporating road and building maintenance. The in-game environment is thus made consistent with the detected real-life construction sound. Again, one or more other functionalities available to the user could also be used to help provide an-game environment which is consistent with the real-life environment. For example, if the game audio is output by noise cancelling headphones worn by the user, the noise cancellation may be deactivated (or the level of noise cancellation may be reduced) so the real-life construction sound can be heard.

It will be appreciated that FIG. 7 is only an example and that the present technique provides significant flexibility to video game designers to associate classified sounds and detected user moods (that is, mood classifications, such as “High” and “Low” in the above example) with corresponding in-game occurrences.

In an example, the sound classification and/or mood detection steps may be carried out by functionality of the operating system (OS) of the games console 110 and/or via an application programing interface (API) made available by the games console provider. This allows the current sound classification and/or current detected mood of the user to be obtained by the video game software application and used with the lookup table provided as part of that video game software application to determine and execute a corresponding in-game occurrence. This provides video game developers with flexibility in creating in-game occurrences for a particular video game without needing to worry about the sound and mood classification processes (which are handled by the OS and/or API).

Classifying the mood of the user may occur in any suitable way. In a simple example, the user may simply manually indicate their mood as “Low” or “High” (e.g. via a suitable menu system or the like) at the start of the gaming session. In other examples, one or more detected physiological characteristics of the user may be used to determine a likely mood of the user.

In an example, facial emotional recognition (FER) is used to determine a user's likely mood from their facial expression (the user's facial expression being an example of a physiological characteristic of a user). Various FER techniques are known in the art and are not discussed in detail here. In an example, a camera (e.g. that of integrated camera and microphone 120) is used to capture image(s) of the user as they play the video game. These image(s) are then classified (e.g. as “High” or “Low”) using a suitable FER technique to determine the user's mood.

Such image(s) may be used to determine a mood classification from a greater number of possible classifications. For instance, rather than a user's mood simply being classified as “High” or “Low”, the user's mood may be classified as “Happy”, “Sad”, “Fearful”, “Disgusted” “Relaxed”, “Stressed”, “Bored”, etc. using a suitable FER technique. Each of these classifications will then be associated with a corresponding in-game occurrence for a given sound classification.

Such image(s) may also be used in combination with one or more other detected physiological characteristics of the user to allow mood determination more accurately. For example, a user's heart rate may be monitored (e.g. when a peripheral device 205 with a user interface 203 comprising a PPG sensor is used) and a user's mood may be determined based on both an image of the user's face and the user's heart rate at a given time. This may help distinguish more accurately between a user being “Bored” or being “Stressed”, for instance.

Thus, for example, if a user's facial expression indicates, via FER, a 50% chance they are “Bored” and a 50% chance they are “Stressed”, it may be determined whether the user's heart rate is above or below a predetermined threshold. If the heart rate is above (or equal to) the predetermined threshold, it is determined that the user is “Stressed” and an in-game occurrence associated with the user being “Stressed” is executed. This may be an in-game occurrence associated with the classified sound which is more likely to have a calming effect on the user (e.g. by making it sunny in the game when the sound of “Rainfall” is detected). On the other hand, if the heart rate is below the predetermined threshold, it is determined that the user is “Bored” and an in-game experience associated with the user being “Bored” is executed. This may be an in-game occurrence associated with the classified sound which is more likely to have a stimulating effect on the user (e.g. by causing a thunderstorm in the game when the sound of “Rainfall” is detected).

It will be appreciated that other techniques to determine a player's mood may be used instead of or in addition to SER. For example, speaker emotion recognition (SER) may be used to detect the player's mood from speech uttered by the player (e.g. during voice chat). An example technique for SER is described in J. Wagner et al., “Dawn of the Transformer Era in Speech Emotion Recognition: Closing the Valence Gap,” in IEEE Transactions on Pattern Analysis and Machine Intelligence, vol. 45, no. 9, pp. 10745-10759, 1 Sep. 2023, doi: 10.1109/TPAMI.2023.3263585.

This demonstrates how the present technique is able to take into account multiple factors in the user's real life environment (including both detected sounds and one or more physiological characteristics of the user indicating their emotional state) to provide a bespoke, immersive gaming experience for the user.

In an example, to provide increased user flexibility, the user is able to manually indicate (e.g. via a suitable menu system or the like) whether they wish their in-game experience to complement or contrast with what is happening in the real world. In this case, each in-game occurrence of the lookup table of FIG. 7 may be flagged (e.g. using an additional column of the lookup table indicating “0” or “1”) to indicate whether it complements or contrasts the classified sound with which it is associated.

Thus, for example, the in-game occurrence “Sunshine” in FIG. 7 may be flagged with a “1” (indicating it contrasts with the associated classified sound “Rainfall”) and the in-game occurrence “Quiet library” may also be flagged with a “1” (indicating it contrasts with the associated classified sound “Construction site”). If the user indicates they desire a gaming experience which, in general, contrasts with the real world, the in-game occurrences “Sunshine” and “Quiet Library” will be executed, respectively, in response to detection of “Rainfall” or “Construction site” sounds (instead of the “Rainfall” and “Busy city street” in-game experiences).

On the other hand, the in-game occurrence “Rainfall” in FIG. 7 may be flagged with a “0” (indicating it complements the associated classified sound “Rainfall”) and the in-game occurrence “Busy city street” may also be flagged with a “0” (indicating it complements the associated classified sound “Construction site”). If the user indicates they desire a gaming experience which, in general, complements the real world, the in-game occurrences “Rainfall” and “Busy city street” will be executed, respectively, in response to detection of “Rainfall” or “Construction site” sounds (instead of the “Sunshine” and “Quiet library” in-game experiences).

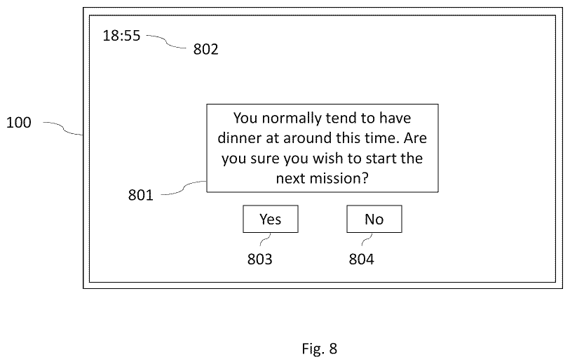

FIG. 8 shows another example in which the detection of sound with one or more particular characteristics may be used by the games console 110 to provide a bespoke experience for a given user.

In this example, as well as different types of sound being classified and used to generate corresponding in-game occurrences as mentioned above, speech in audio detected by the microphone may be analysed by the classifier 302 to pick up keywords and/or determine the context of the speech (e.g. using any suitable known large language model LLM implemented by a server (not shown) connected to the games console 110) and associate that speech with actions taken by the user.

Here, it has been determined that, previously (e.g. two or more times in an immediately preceding a first predetermined time period, e.g. the last week), speech was picked up by the microphone indicating that the player (e.g. a child) was called to have dinner at around 19:00 hours (e.g. on three occasions in the past week, all within a second predetermined time period, e.g. 5 minutes, of 19:00 hours). In response to this (e.g. within a third predetermined time period, e.g. 1 minute, of the speech being detected), the player stopped playing the game and did not return to playing the game until the next evening.

The games console 110 uses such information gathered from the past to help guide the player's future gaming behaviour. In the example of FIG. 8, for instance, the time (as indicated by on-screen clock 802) is 18:55 (that is, within the time period during which the player is normally called to have dinner) and the player has just selected to start a new mission. However, based on the past information, the games console 110 is aware that the user may soon be called to dinner and will thus likely stop playing the game until the next evening. An on-screen message 801 is thus displayed indicating the user is likely to be called for dinner soon and asking whether the user is sure they wish to start the new mission. The user is then able to select either the “Yes” virtual button 803 (to continue with the new mission) or “No” virtual button 804 (to not continue with the new mission). The user may also be presented with an alternative to the new mission, for example, a mini game within the main game which the user is likely to be able to complete (e.g. in 5 minutes or less) before they are called to dinner.

FIG. 8 is only one example and, more generally, the present technique enables a relationship to be determined between contexts of speech included in previous captured audio samples (e.g. those relating to a user being called to dinner), previous interactions between the player and the video game occurring in response to the speech of the previous audio samples (e.g. the user stopping play and not continuing until the following evening) and capture times of the previous captured audio samples (e.g. the user being called to dinner and stopping play tends to happen at around 19:00 hours). A suggestion is then output to the player based on the determined relationship (e.g. the on-screen message 801 reminding the user they may be called to dinner and will have to stop playing when, at around 19:00 hours, they attempt to start a new mission).

The provision of the on-screen message 801 for outputting information to the user is only an example and various ways of providing this information may be used. For example, for a more subtle implementation, rather than displaying the on-screen message 801 when it is close to the time a user usually has dinner, one or more NPCs may be controlled to start talking about dinner or food or asking the player if they are getting hungry.

This provides another example of how detected sound may be used to take into account what is happening in a user's physical environment and provide a bespoke experience for the user accordingly.

The present technique may also be applied to audio-based video games themselves. For example, there exist music-based games on which a user is presented with visual cues in response to which a user must perform a particular physical action (such as perform a particular dance move, control a special type of instrument-themed controller or perform a slicing or sword-like action). Normally, such games are based on pre-recorded audio tracks. However, with the present technique, sounds in the user's real life environment detected by the microphone could be incorporated in such video games.

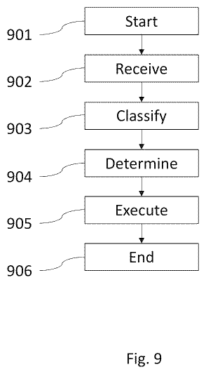

FIG. 9 shows an example computer-implement method. The method is executed by the CPU 20 and/or GPU 30 of games console 110, for example.

The method starts at step 901.

At step 902, data indicating an audio sample captured (e.g. by a microphone) in a physical environment of a player of a video game is received.

At step 903, a classification of the audio sample (e.g. via classifier 302).

At step 904, an in-game occurrence associated with the determined classification of the audio sample is determined. This is done using a lookup table, for example, to associate the audio classification “footsteps” with the appearance of character 402 (see FIG. 4B), the audio classification “rain” with the change in in-game weather from sunny to rainy (see FIG. 5B) and the audio classification “voices” with NPCs 601 and 602 beginning to converse (see FIG. 6B).

At step 905, the determined in-game occurrence is executed in the video game.

The method ends at step 906.

Example(s) of the present technique are defined by the following numbered clauses:
1. A data processing apparatus comprising circuitry configured to:
receive data indicating an audio sample captured in a physical environment of a player of a video game;
determine a classification of the audio sample;
determine an in-game occurrence associated with the determined classification of the audio sample; and
control the determined in-game occurrence to be executed in the video game.
   2. A data processing apparatus according to clause 1 wherein, if the classification of the audio sample indicates there is no detectable sound in the physical environment of the player, the circuitry is configured to control a default in-game occurrence to be executed in the video game.
   3. A data processing apparatus according to clause 1 or 2, wherein the circuitry is configured to control filtering to be performed to suppress a presence of audio generated by the video game in the audio sample prior to classification of the audio sample.
   4. A data processing apparatus according to clause 3, wherein the circuitry is configured to skip controlling the filtering to be performed if it is determined the audio generated by the video game is to be output to personal audio speakers.
   5. A data processing apparatus according to any preceding clause, wherein:
the classification of the audio sample is associated with a plurality of selectable in-game occurrences; and
the determined in-game occurrence is selected based on information associated with the player of the video game.
   6. A data processing apparatus according to clause 5, wherein:
the information associated with the player is emotional state information indicating an emotional state of the player; and
each of the plurality of selectable in-game occurrences is associated with a different emotional state of the player.
   7. A data processing apparatus according to any preceding clause, wherein the in-game occurrence relates to behaviour of one or more non-player characters in the video game.
   8. A data processing apparatus according to any preceding clause, wherein the in-game occurrence relates to simulated weather conditions in the video game.
   9. A data processing apparatus according to any preceding clause, wherein the circuitry is configured to:
determine a relationship between contexts of speech included in previous captured audio samples and previous interactions between the player and the video game occurring in response to the speech of the previous audio samples; and
control output of a suggestion to the player based on the determined relationship.
   10. A computer-implemented data processing method comprising:
receiving data indicating an audio sample captured in a physical environment of a player of a video game;
determining a classification of the audio sample;
determining an in-game occurrence associated with the determined classification of the audio sample; and
controlling the determined in-game occurrence to be executed in the video game.
   11. A program for controlling a computer to perform a method according to clause 10.
   12. A computer-readable storage medium storing a program according to clause 11.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
receive data indicating an audio sample captured in a physical environment of a player of a video game;
determine a classification of the audio sample;
determine an in-game occurrence associated with the determined classification of the audio sample; and
control the determined in-game occurrence to be executed in the video game.

2. A data processing apparatus according to claim 1 wherein, if the classification of the audio sample indicates there is no detectable sound in the physical environment of the player, the circuitry is configured to control a default in-game occurrence to be executed in the video game.

3. A data processing apparatus according to claim 1, wherein the circuitry is configured to control filtering to be performed to suppress a presence of audio generated by the video game in the audio sample prior to classification of the audio sample.

4. A data processing apparatus according to claim 3, wherein the circuitry is configured to skip controlling the filtering to be performed if it is determined the audio generated by the video game is to be output to personal audio speakers.

5. A data processing apparatus according to claim 1, wherein:
the classification of the audio sample is associated with a plurality of selectable in-game occurrences; and
the determined in-game occurrence is selected based on information associated with the player of the video game.

6. A data processing apparatus according to claim 5, wherein:
the information associated with the player is emotional state information indicating an emotional state of the player; and
each of the plurality of selectable in-game occurrences is associated with a different emotional state of the player.

7. A data processing apparatus according to claim 1, wherein the in-game occurrence relates to behaviour of one or more non-player characters in the video game.

8. A data processing apparatus according to claim 1, wherein the in-game occurrence relates to simulated weather conditions in the video game.

9. A data processing apparatus according to claim 1, wherein the circuitry is configured to:
determine a relationship between contexts of speech included in previous captured audio samples and previous interactions between the player and the video game occurring in response to the speech of the previous audio samples; and
control output of a suggestion to the player based on the determined relationship.

10. A computer-implemented data processing method comprising:
receiving data indicating an audio sample captured in a physical environment of a player of a video game;
determining a classification of the audio sample;
determining an in-game occurrence associated with the determined classification of the audio sample; and
controlling the determined in-game occurrence to be executed in the video game.

11. A non-transitory computer-readable storage medium storing a program for controlling a computer to perform a data processing method, the method comprising:
receiving data indicating an audio sample captured in a physical environment of a player of a video game;
determining a classification of the audio sample;
determining an in-game occurrence associated with the determined classification of the audio sample; and
controlling the determined in-game occurrence to be executed in the video game.
